(19) United States
(12) Patent Application Publication
(10) Pub. No.: US 2016/0142910 A1
(43) Pub. Date: May 19, 2016

(54) STORAGE DEVICE WITH SRWC (SHORT-RANGE WIRELESS COMMUNICATION) DEVICE TAG AND METHOD FOR ACCESSING STORAGE DEVICE

(71) Applicant: Solid State System Co., Ltd., Hsinchu (TW)

(72) Inventor: Tai-Yao Lee, Hsinchu City (TW)

(21) Appl. No.: 14/542,668

(22) Filed: Nov. 17, 2014

(51) Int. Cl. H04W 12/06; G06F 12/02; H04L 29/06; G06F 12/14

(52) U.S. Cl. CPC H04W 12/06; G06F 12/1483; G06F 12/0246; H04L 63/083; H04L 63/0853; H04L 63/0492; G06F 2212/1052; G06F 2212/7209

(57) ABSTRACT

A short-range wireless communication (SRWC) mobile storage device includes a portable storage device and a SRWC device tag. The SRWC device tag has a non-volatile memory for storing an access-control setting information. If the access-control setting information has already been set with required parameters and when the portable storage device with the SRWC device tag is connected to a master equipment, the portable storage device is automatically switched to a secured private zone for the master equipment to access.

### BACKGROUND OF THE INVENTION

1. Field of Invention

The present invention relates to a storage device with a short-range wireless communication (SRWC) device tag and method for accessing the storage device.

2. Description of Related Art

A portable storage device, such as flash drive or USB flash drive, has been a popular tool for storing massive information and can be conveniently carried by a user. In addition, the USB interface is also one of the popular interfaces for communicating with other electronic systems such as computer systems or personal computer systems. The USB flash drive becomes a very popular digital product. For the application of the USB flash drive, the USB flash drive can store massive information and can be plugged to the computer system or any equipment with the USB interface for accessing the USB flash drive.

For protecting the stored information in the USB flash drive, the USB flash drive would usually be partitioned into a public area and a secured area. When the USB flash drive connected to the USB equipment, such as personal computer system or any USB apparatus, the public area can be freely accessed. However, the equipment needs to pass a security procedure to access the secured area of the USB flash drive. This is not convenient for the user, and there is a possibility that some security information could be revealed to the public.

### SUMMARY OF THE INVENTION

The invention provides a SRWC mobile storage device with a short-range wireless communication (SRWC) device tag such as near-field communication (NFC) tag. The user can conveniently use a mobile apparatus to write an access-control setting information into the SRWC device tag.

In an embodiment, a short-range wireless communication (SRWC) mobile storage device includes a portable storage device and a SRWC device tag. The SRWC device tag has a non-volatile memory for storing an access-control setting information. If the access-control setting information has already been set with required parameters and when the portable storage device with the SRWC device tag is connected to a master equipment, the portable storage device is automatically switched to a secured private zone for the master equipment to access.

In an embodiment, a method of access-control control for a portable storage device is provided, wherein a storage space of the portable storage device is partitioned into a public zone and a private zone and a short-range wireless communication (SRWC) device tag with a non-volatile memory is implemented with the portable storage device. The method includes writing an access-control setting information into the non-volatile memory of the SRWC device tag by using an electronic mobile apparatus through a SRWC interface. In addition, a flag is set in the non-volatile memory, used to automatically switch to the private zone. The non-volatile memory with the flag is switched to the private zone when the portable storage device is connected to a master equipment, wherein the master equipment access the portable storage device according to the access-control setting information.

For easy descriptions, a NFC device is taken as an example for the SRWC devices in the following description, but the invention is not limited to this specific communication technology. It should be noted that the NFC tag here is one of the technology choices for the communication within short-range distance in the invention. It can be generally applied to the short-range wireless communication (SRWC) device based on the communication technology in current state of the art or even based on the communication technology being developed later. The range of the short-range wireless communication is for example referring to a distance within about one meter. Besides NFC device, the communication device in short-range may be an ultrasonic device which transmits the ultrasonic wave and captured and decoded by a microphone and/or actuator. The communication device could be infrared, or any suitable manner. For easy descriptions, the NFC technology is taken as the example in the invention for short-range communication technology but the invention is not just limited to the specific communication technology.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a drawing, schematically illustrating a mechanism of access control of a storage device, according to an embodiment of the invention.

FIG. 2 is a drawing, schematically illustrating a procedure for producing capacity status and content list of a storage device in NFC tag, according to an embodiment of the invention.

FIG. 3 is a drawing, schematically illustrating a mechanism for obtaining capacity status and content list of a storage device from NFC tag, according to an embodiment of the invention.

### DESCRIPTION OF THE PREFERRED EMBODIMENTS

In the digital world, an electronic mobile apparatus, such as mobile phone, has already been very popular in communication. In addition, a near-field communication (NFC) tag as a passive device, like the RFID tag, has also been developed to store a small amount of data to identify a device or equipment. The NFC technology allows the mobile phone or any equipment installed with NFC application software (APP) to read/write the information from/onto the NFC tag. So, the mobile phone can easily write information to or read information from the NFC tag within short distance, such as about 10 cm, in wireless manner.

When considering the popularity of the portable storage device, the electronic mobile apparatus, and NFC tag, the invention propose a portable storage device implemented with the NFC tag, so the access control of the portable storage device can be set by the electronic mobile apparatus, such as mobile phone. When the portable storage device with NFC tag is connected to the equipment such as desk-top computer, personal computer (PC), or any master apparatus capable being connected with the portable storage device, the equipment can access the private zone of the portable storage device. The equipment is not necessary to run a security procedure to get authorization for accessing the portable storage device. This application can be more convenient for accessing with the need of security because the access control is set in the NFC tag.

Because the mobile phone and the USB communication interface have been very popular in digital world, mobile phone and the USB flash drive are taken as the examples for describing the invention. However, the mobile apparatus is not just limited to the mobile phone and the portable storage device is not just limited to the USB flash drive. The mobile phone can be changed to tablet computer or mobile digital apparatus, and can be general referred as an electronic mobile apparatus.

Here, mobile phone is an example but not the only choice. For example, in other embodiments, the tablet PC with the SRWC function can be used. The mobile phone can be generally referred as an electronic mobile apparatus with the SRWC function. Also remarkably, the USB storage device is a popular storage device in the current market. However, the invention is not just limited to the USB storage device. Any storage device with the interface other than USB can also be applied with the technology of the invention, such as memory stick, SD card, mobile hard disk, or any like device.

Several embodiments are provided for describing the invention. However, the invention is not just limited to the embodiments.

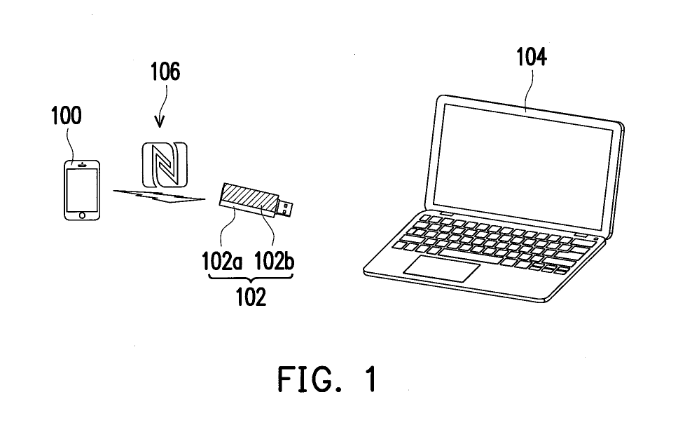

FIG. 1 is a drawing, schematically illustrating a mechanism of access control of a storage device, according to an embodiment of the invention. In FIG. 1, generally, a NFC portable storage device 102 includes a portable storage device 102a and a NFC tag 102b. As previously stated, the NFC technology, as well known in the art, is just used for easy description. The NFC portable storage device 102 can be generally referred to a SRWC mobile storage device.

The storage space of the portable storage device 102a is usually partitioned into a public zone and a private zone. A NFC tag is implemented on the NFC mobile storage device 102, wherein the NFC tag 102b has a non-volatile memory for storing an access-control setting information set by an electronic mobile apparatus 100, such as mobile phone, tablet computer, or mobile digital apparatus via an application software (APP) for security control setting. When the portable storage device 102a with the NFC tag 102b is connected to a master equipment 104, such as a personal computer, the portable storage device 102a will behave according to the preset access-control setting information.

In the mechanism shown in FIG. 1, the access-control setting information may comprise a time-out control. In addition, the access-control setting information may also comprise a protection mode for allowing only N times of access to a private zone of the portable storage device, N is an integer greater than 0. Generally, a storage space of the portable storage device 102a, such as USB flash drive, can be partitioned into a public zone and a private zone, and then the access-control setting information comprises an identification and a password. An authentication code is generated from the identification and password to authorize the access to the private zone when the NFC mobile storage device 102 is connected to a master equipment 104. However, the portable storage device 102a is not always requested to be partitioned into the public zone and the private zone. If the zone partition is not needed by the user, the portable storage device 102a as a whole is simply treated as a public storage device. In this situation, the portable storage device 102a has public zone only.

The portable storage device 102a can be any one of USB flash drive, memory stick, SD card and so on. The memory of the NFC tag is nonvolatile, erasable and programmable, such as EEPROM or flash memory. It can also store a capacity status for indicating a storage space being currently available and a content list of the downloaded contents stored in the portable storage device. In addition, the capacity status and the content list are to be read by any equipment installed with NFC APP.

For the general procedure, the vendor of the NFC mobile storage device would provide a security control setting APP which is usually located in a website. For example, when the user purchases the NFC mobile storage device, the user can download the security control setting APP from the website to an electronic mobile apparatus, such as the smart phone, tablet computer, or any smart apparatus. The NFC tag as purchased has a unique identification (UID). Then, the security control setting APP can be executed in the electronic mobile apparatus, so the user can input an intended password. With the password and the UID of the NFC tag, the security control setting APP will produce an authentication code. The security control setting APP would then take the authentication code to register to the website of storage device vendor and also store the authentication code to the non-volatile memory of the NFC tag through the NFC interface.

Another software, referring to partition software, can be also downloaded from the website of the storage device vendor to the master equipment such as personal computer. User can run this partition software when he wants to partition the storage space. The downloaded partition software reads authentication code from the memory of NFC tag 102b and verifies with the authentication code registered in the website. If the authentication code is correct, the partition software starts to partition the storage space of the portable storage device 102a into a public zone and a private zone. And the zone size is specified by the user.

After partitioning, the private zone can still not be accessed yet when the NFC mobile storage device 102 is connected to the computer. The NFC tag of the NFC mobile storage device 102 still further needs an access control setting procedure via the downloaded security control setting APP. The access control setting procedure would set the access control parameters, which provide an access control information and are stored to the non-volatile memory of the NFC tag. The accessibility of the private zone in the invention will work according to the preset parameters when the NFC mobile storage device 102 is connected to the computer next time.

In the embodiment as an example, the private zone of the portable storage device cannot be accessed when the portable storage device is plugged to the computer before setting the access control on the NFC tag for the portable storage device. The NFC tag integrated with the portable storage device is then set with access control information by electronic mobile apparatus using the downloaded security control setting APP. Here, the NFC interface as preciously stated can be generalized as the SRWC (short-range wireless communication) interface. The electronic mobile apparatus can be smart phone, PDA, tablet computer and so on. They have the capability to run the security control setting APP with NFC interface and serve as hosts.

The electronic mobile apparatus allows the user to set the access control information, which is then stored in the non-volatile memory of the NFC tag. So, after the setting to access to the private zone of the portable storage device through the electronic mobile device, the master equipment can access the private zone based on the access control information. In an example, the portable storage device 102a carries a firmware, which reads the access control information and checks whether the private zone is still under accessible condition. If it's under accessible condition, the private zone will be able to be read and written by the master equipment.

The access control information includes a parameter N in an example. The parameter N is, for example, a non-negative integer and it is the number of allowed accessing times to the private zone. Each time, after accessing the private zone, the parameter N is subtracted by one in the example. When the value of the parameter N is equal to 0, the private zone can not be accessed unless setting a positive number to the parameter N before accessing it. However, negative integer can also be alternatively used to indicate failure of access or any other information about control the access.

Besides the number of access time, the access control information may include a parameter of maximum accessing time T. When the storage device plugged into the master equipment, the maximum accessing time T will start counting down. If time-out occurs, access to the private zone will be terminated. The implementation of the maximum accessing time can be that it counts down when the master equipment starts accessing the private zone. It can be noted that the invention is not just limited to the embodiments described above only. A further detail in example would be described below.

The mechanism of access control can be divided into several parts as needed. Embodiments are further provided for descriptions but not for restriction of the invention. The mechanism of access control may include a step, in which an APP of the electronic mobile apparatus 100, such as mobile phone, sets an access control count to N when the electronic mobile apparatus 100 connects to the NFC mobile storage device 102 via NFC interface 106. N is a non-negative integer, so as to allow only N times of access.

In further step, a flag in the memory of the NFC tag is set to indicate automatically switching to the private zone by the electronic mobile apparatus 100. In further step, the portable storage device 102a is plugged to master equipment 104 and the portable storage device 102a will switch to the private zone for accessing by the computer.

In other words, if the access-control setting information has already been set with required parameters and when the portable storage device with the SRWC device tag is connected to a master equipment, the portable storage device is automatically switched to a secured private zone for the master equipment to access the secured private zone. It can also be noted that the required parameters for the access-control setting information are not just limited to the examples provided in the present invention and will depend on the actual design as required. When the access-control setting information is still at valid status, then the portable storage device can be automatically switched to a secured private zone.

In addition, a time-out control may be set in the access-control setting information, so as to restrict the accessible time duration of the NFC mobile storage device 102 by setting a maximum accessing time or time-out value.

The time-out control in an example may include a step, in which the mobile phone APP may set the time-out value to the memory of the NFC tag. In further step, as an example, the USB flash drive plugs to a master equipment such as a personal computer. In further step, the time-out value is loaded to the controller of the portable storage device and then the time-out value is cleared from the non-volatile memory, such as EEPROM, of the NFC tag for one time access. In further step, the time-out could be an accumulation of time in use, by accumulating elapse time or operation time. In other words, the time-out value would compare with the accumulation of time in use. As a result, the portable storage device 102a will switch back to public zone.

It can be noted that the way to set the time-out may be done in other procedure. The foregoing procedure is just an example to set time-out function with the NFC tag.

Further, a data protection mode can also be set in the access-control setting information. Under data protection mode, all files in FAT (file allocation table, FAT) be marked off, i.e. be deleted or data blocks will be erased if the storage device is plugged to the mater equipment with zero time allowed for access or zero access time duration. As a result, the data in the NFC mobile storage device 102 no longer exist.

For the above control setting, following features can be an implementation example when time-out control is triggered. When the private zone is allowed for accessing, i.e. N>0, the device will be switched back to public zone right away as the time-out event happens. The time-out control setting will be cleared. If the device is plugged out of master equipment before time-out triggered, the time-out control setting will be cleared also.

For the further applications to the NFC tag 102b implemented onto the portable storage device 102a, the remaining capacity and the content list of files stored in the portable storage device 102b can be easily obtained by the electronic mobile apparatus 100 from the non-volatile memory of the NFC tag 102b.

A mechanism for storing a capacity status and content list of a storage device into NFC tag is further described, according to an embodiment of the invention. When the NFC mobile storage device 102 plugs to the master equipment 104, the master equipment 104 may download a new file into the storage device, such as movie file or music file or delete a file from it, so the content and the remaining storage capacity of the NFC mobile storage device 102 would be changed. In the embodiment, a content list can be updated and stored in the non-volatile memory of the NFC tag when the portable storage device is connected to a master equipment and when a file is written to or deleted from the portable storage device by the master equipment. Then, a remaining capacity in the portable storage device can be calculated, and a capacity status of the remaining capacity can be written into the non-volatile memory of the NFC tag.

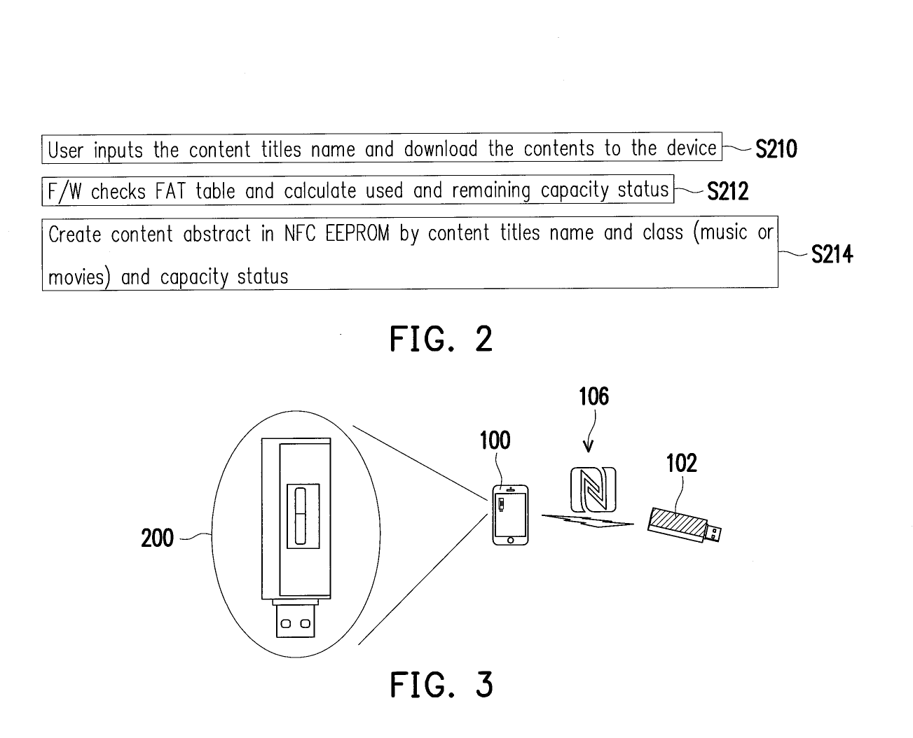

FIG. 2 is a drawing, schematically illustrating a procedure for producing capacity status and content list of a storage device in NFC tag, according to an embodiment of the invention. In FIG. 2, a procedure as an example to produce the capacity status and content list is described. In step S210, a user may input the content titles name and download the contents to the NFC tag of USB flash device. In step S212, USB controller runs with the firmware to check FAT table and calculates the capacity status about the used and remaining capacity. In step S214, a content abstract is created in the non-volatile memory of the NFC tag 102b by content titles name and class in music or movies and capacity status, as an example. So, the content list of the content stored in the NFC mobile storage device 102 and the capacity status can be updated and stored in the non-volatile memory of the NFC tag.

It can be noted that the way to create content list and capacity status may be done in other procedure. FIG. 2 is just an embodiment as an example not for limiting the invention.

Here, the access-control may be involved but is not absolutely necessary. The information of the capacity status and content list of the mobile storage device 102 can be obtained by the electronic mobile apparatus 100 mobile phone.

FIG. 3 shows that when the content list and the capacity status is stored in the NFC tag, the content list and the capacity status can be obtained by an electronic mobile apparatus 100, such as mobile phone through the NFC APP 106. Since the electronic mobile apparatus 100 has a screen display, the content list and the capacity status can be easily shown on the screen of the electronic mobile apparatus 100 by touch operation or any other manner. With no need of plugging the storage device into the mater equipment, the user can easily get the title information of those contents stored in the portable storage device via the NFC interface.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A short-range wireless communication (SRWC) mobile storage device, comprising:
a portable storage device; and
a SRWC device tag, wherein the SRWC device tag has a non-volatile memory for storing an access-control setting information,
wherein if the access-control setting information has already been set with required parameters and when the portable storage device with the SRWC device tag is connected to a master equipment, the portable storage device is automatically switched to a secured private zone for the master equipment to access the secured private zone.

2. The SRWC mobile storage device of claim 1, wherein the access-control setting information are set by an electronic mobile apparatus via a SRWC interface.

3. The SRWC mobile storage device of claim 1, wherein the storage device is partitioned into a secured private zone and a public zone;

4. The SRWC mobile storage device of claim 1, wherein the access-control setting information comprises a time-out value for restricting an access time to access the private zone.

5. The SRWC mobile storage device of claim 1, wherein the access-control setting information comprises a protection mode for permitting only N times of access right to the private zone, wherein the N is a non-negative integer.

6. The SRWC mobile storage device of claim 1, wherein the access-control setting information comprises an identification name and a password for authentication to access the private zone.

7. The SRWC mobile storage device of claim 1, wherein the private zone cannot be accessed when the access-control setting information is reset to an initial state or a null state.

8. The SRWC mobile storage device of claim 1, wherein the non-volatile memory of the SRWC device tag stores a capacity status for indicating a size of the available storage space.

9. The SRWC mobile storage device of claim 1, wherein the non-volatile memory of the SRWC device tag stores a content list of a down-load content stored in the portable storage device.

10. The SRWC mobile storage device of claim 1, wherein the portable storage device is a USB flash drive and the electronic mobile apparatus is a mobile phone, a tablet computer, or a mobile digital apparatus.

11. The SRWC mobile storage device of claim 1, wherein the SRWC device tag is a near-field communication (NFC) tag.

12. The SRWC mobile storage device of claim 1, wherein the SRWC device tag is an ultrasonic device tag which uses microphones to receive the ultrasonic wave.

13. A method of access-control control for a portable storage device, wherein a storage space of the portable storage device is partitioned into a public zone and a private zone and a short-range wireless communication (SRWC) device tag with a non-volatile memory is implemented with the portable storage device, the method comprising:
writing an access-control setting information into the non-volatile memory of the SRWC device tag by using an electronic mobile apparatus through a SRWC interface;
setting a flag in the non-volatile memory, used to automatically switch to the private zone; and
switching to the private zone when the portable storage device with the flag is connected to a master equipment, wherein the master equipment access the portable storage device according to the access-control setting information.

14. The method of access-control control as recited in claim 13, wherein the access-control setting information further comprises a time-out control, so the master equipment has a limited time interval for accessing the private zone.

15. The method of access-control control as recited in claim 13, wherein the access-control setting information further comprises a protection mode for only N times of access to the private zone, wherein the N is a positive integer.

16. The method of access-control control as recited in claim 13, wherein the private zone cannot be accessed when the access-control setting information is reset to an initial state or a null state.

17. The method of access-control control as recited in claim 13, further comprising:
storing a capacity status for indicating a storage space being currently available and a content list of a downloaded content stored in the portable storage device into the non-volatile memory of the SRWC device tag; and
reading and displaying the capacity status and the content list by the electronic mobile apparatus through the SRWC interface.

18. The method of access-control control as recited in claim 13, wherein the portable storage device is a USB flash drive and the electronic mobile apparatus is a mobile phone, a tablet computer, or a mobile digital apparatus.

19. The method of access-control control as recited in claim 13, wherein the SRWC device tag is a near-field communication (NFC) tag.
